(19) United States
(12) Patent Application Publication
(10) Pub. No.: US 2025/0230980 A1
(43) Pub. Date: Jul. 17, 2025

(54) HEAT TREATMENT APPARATUS

(71) Applicant: Noritake Co., Limited, Nagoya-shi (JP)

(72) Inventors: Hidenori Nakamura, Nagoya-shi (JP); Hideaki Ohi, Nagoya-shi (JP); Masaki Iida, Nagoya-shi (JP)

(73) Assignee: Noritake Co., Limited, Nagoya-shi (JP)

(21) Appl. No.: 19/017,074

(22) Filed: Jan. 10, 2025

(30) Foreign Application Priority Data
Jan. 11, 2024 (JP) 2024-002837

(51) Int. Cl. F27B 5/04; F27B 5/06; F27D 1/18; F27D 9/00; F27D 99/00; H01M 4/04

(52) U.S. Cl. CPC F27B 5/04; F27D 1/1858; F27D 9/00; F27D 99/0073; H01M 4/0471; F27B 2005/062; F27D 2009/0018

(57) ABSTRACT

A heat treatment apparatus includes a furnace body, a door, and a pipe. The furnace body has therein a processing space where the workpiece is heat-treated, and it is provided with an opening. The door closes the opening of the furnace body. A refrigerant flows through the pipe. The door is provided with a seal material in a region that overlaps a peripheral edge of the opening of the furnace body when the door is closed. The pipe is attached around a region in the furnace body against which the seal material is pressed.

### CROSS REFERENCE TO RELATED APPLICATION(S)

This application claims benefit of priority to Japanese Patent Application No. 2024-002837 filed on Jan. 11, 2024, the entire contents of which are hereby incorporated herein by reference.

### BACKGROUND OF THE DISCLOSURE

The present disclosure relates to a heat treatment apparatus.

Japanese Patent Publication No. 7285360 discloses a heat treatment apparatus that includes an unwinding unit, a heat treatment unit, a cooling unit, and a winding unit. In the heat treatment unit, a strip-shaped workpiece unwound from an unwinding roll provided in the unwinding unit is heat-treated while being conveyed.

### SUMMARY

The present inventors aimed to maintain airtightness in a heat treatment apparatus equipped with a door configured to be openable and closable.

A heat treatment apparatus disclosed herein includes a furnace body, a door, and a pipe. The furnace body has therein a processing space where the workpiece is heat-treated, and it is provided with an opening. The door closes the opening of the furnace body. A refrigerant flows through the pipe. The door is provided with a seal material in a region that overlaps a peripheral edge of the opening of the furnace body when the door is closed.

The pipe is attached around a region in the furnace body against which the seal material is pressed. In the heat treatment apparatus with this configuration, the airtightness of the heat treatment apparatus is maintained.

### BRIEF DESCRIPTION OF THE DRAWINGS

FIG. 1 is a schematic diagram illustrating a heat treatment apparatus 10.

FIG. 2 is a perspective view of a heat treatment unit 40 with a door 46 opened.

FIG. 3 is a perspective view of the heat treatment unit 40 with the door 46 closed.

FIG. 4 is a schematic diagram of a hinge 48.

### DETAILED DESCRIPTION OF THE INVENTION

One embodiment in the present disclosure will be described in detail below with reference to the drawings. In the following drawings, members and portions that have the same actions are denoted by the same symbols. The dimensional relationships (length, width, thickness, etc.) in each drawing do not reflect the actual dimensional relationships. The directions of up, down, left, right, front, and back are represented are represented by arrows U, D, L, R, F, and Rr, respectively, in the figures. Here, the directions of up, down, left, right, front, and back are only provided for convenience of explanation and do not limit the present disclosure unless otherwise specifically mentioned.

### <Heat Treatment Apparatus 10>

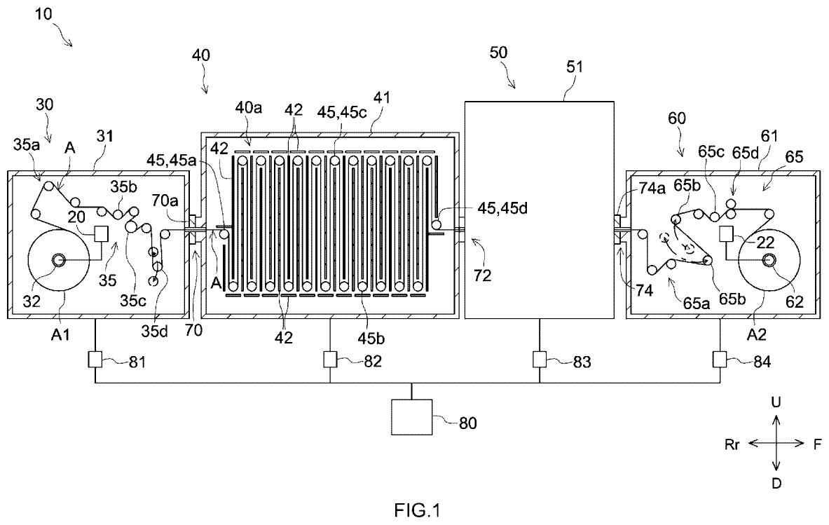

FIG. 1 is a schematic diagram illustrating a heat treatment apparatus 10. The heat treatment apparatus 10 is equipment for performing heat treatment on a strip-shaped (sheet-shaped) workpiece A, which is an object to be processed. In this embodiment, the heat treatment apparatus 10 is a device for continuously drying a strip-shaped workpiece while conveying it in a so-called roll-to-roll system. The workpiece A is not particularly limited as long as it is a strip-shaped object, such as an electrode sheet for secondary batteries that has an electrode material applied to both sides of a sheet base, a Flexible Copper Clad Laminate (FCCL), or a polyimide sheet. The heat treatment apparatus 10 can be used to perform the treatment on a variety of strip-shaped (sheet-shaped) workpieces.

The heat treatment apparatus disclosed herein is not limited to a roll-to-roll type apparatus that performs heat treatment on a strip-shaped workpiece A, but can be applied to various types of heat treatment apparatuses. The configuration of the heat treatment apparatus disclosed herein can be applied to, for example, a so-called roller hearth kiln in which a workpiece is conveyed by a plurality of conveyance rollers arranged along a conveyance direction. The configuration of the heat treatment apparatus disclosed herein is not limited to the roll-to-roll type heat treatment apparatus or a continuous type heat treatment apparatus such as the roller hearth kiln. The configuration of the heat treatment apparatus disclosed herein can also be applied to a so-called batch-type heat treatment apparatus in which a workpiece is heat-treated in a stationary standing state within a furnace.

As illustrated in FIG. 1, the heat treatment apparatus 10 includes an unwinding unit 30, a heat treatment unit 40, a cooling unit 50, and a winding unit 60.

The strip-shaped workpiece A is processed while being conveyed, through the unwinding unit 30, the heat treatment unit 40, the cooling unit 50, and the winding unit 60 in that order. The workpiece A is unwound from an unwinding roll A1 provided in the unwinding unit 30, heat-treated in the heat treatment unit 40, cooled in the cooling unit 50, and then wound onto a winding roll A2 provided in the winding unit 60.

### <Conveyance Devices 20 and 22>

Conveyance devices 20 and 22 are devices that convey the workpiece A. The workpiece A is conveyed along a predetermined conveyance route. The conveyance devices 20 and 22 are devices that rotationally drive an unwinding shaft 32, on which the unwinding roll A1 of the unwinding unit 30 is attached, and a winding shaft 62, on which the winding roll A2 of the winding unit 60 is attached, respectively. Each of the conveyance devices 20 and 22 can be constituted of a device that controls the conveyance of the workpiece A. For example, a motor and an inverter may be used as the conveyance devices 20 and 22, and particularly a servo motor or the like may be used.

The conveyance devices 20 and 22 may include a device that controls a tension applied to the workpiece A. For example, a powder clutch may be used as the device for controlling the tension. The conveyance devices 20 and 22 may be implemented by a system in which a device for controlling the conveyance speed and a device for controlling the tension cooperate with each other.

The unwinding shaft 32 is connected to the conveyance device 20. The unwinding shaft 32 is rotationally driven by the conveyance device 20, thereby unwinding the workpiece A from the unwinding roll A1. The winding shaft 62 is connected to the conveyance device 22. The winding shaft 62 is rotationally driven by the conveyance device 22, thereby winding the workpiece A onto the winding roll A2. The conveyance devices 20 and 22 may be installed in an atmospheric box provided in a space enclosed by outer walls 31 and 61, respectively. The conveyance devices 20 and 22 may be provided outside the outer walls 31 and 61, respectively.

The heat treatment apparatus 10 can be configured to convey the workpiece A at a high speed in order to improve the processing efficiency of the workpiece A. Although not particularly limited, the conveyance speed of the workpiece A can be set to about 1 m/min to 200 m/min. In this embodiment, the conveyance speed of the workpiece A is set to about 100 m/min.

In the heat treatment apparatus 10, the conveyance speed of the workpiece A is controlled by a controller (not illustrated).

The controller controls the conveyance speed of the workpiece A, the tension applied to the workpiece A, and the like such that the workpiece A is conveyed according to a predetermined conveyance condition. The controller respectively controls an unwinding tension applied when the workpiece A is unwound, an in-furnace tension applied to the workpiece A being processed, and a winding tension applied when the processed workpiece A is wound up. The controller is connected to the conveyance devices 20 and 22. The controller may be connected to a tension detection roller 35b, a feed roller 35c, a dancer roller 35d, a tension detection roller 65c, and the like. The controller feeds back the unwinding tension detected by the tension detection roller 35b to the conveyance device 20 and thereby controls the torque of the unwinding shaft 32. Thus, the unwinding tension is adjusted. The controller also feeds back, to the dancer roller 35d, the in-furnace tension detected by the tension detection roller 35b, over which the workpiece A being processed is hung. The dancer roller 35d moves according to the detected in-furnace tension. Thus, the in-furnace tension is adjusted. The rotation speed of the feed roller 35c is controlled such that the position of the dancer roller 35d returns to a reference position with the in-furnace tension being constant. The controller feeds back the winding tension detected by the tension detection roller 65c to the conveyance device 22 and thereby controls the torque of the winding shaft 62. Thus, the winding tension is adjusted.

### <Unwinding Unit 30>

The unwinding unit 30 is equipment that unwinds the workpiece A. The unwinding unit 30 houses the unwinding roll A1 in a state where the workpiece A before the heat treatment is wound thereon.

The unwinding unit 30 has the outer wall 31 that encloses internal equipment and the unwinding roll A1. The unwinding unit 30 includes therein the unwinding shaft 32 and plural rollers 35. The unwinding shaft 32 is a shaft to which the unwinding roll A1, holding the workpiece A wound on it before heat treatment, is attached. In this embodiment, the unwinding shaft 32 is rotationally driven to unwind the workpiece A from the unwinding roll A1 attached to the unwinding shaft 32.

Within the space enclosed by the outer wall 31 of the unwinding unit 30, the plural rollers 35 that set the conveyance route for the workpiece A are provided. The workpiece A unwound from the unwinding roll A1 is hung around and sequentially passed through the plural rollers 35 in a predetermined order and then conveyed toward the heat treatment unit 40.

The plural rollers 35 include guide rollers 35a, the tension detection roller 35b, the feed roller 35c, and the dancer roller 35d. The tension detection roller 35b is a roller for detecting the tension applied to the workpiece A. A tension detector (not illustrated) is attached to the tension detection roller 35b. The dancer roller 35d is configured to be movable within a predetermined range. By moving the dancer roller 35d, the tension applied to the workpiece A is adjusted. The feed roller 35c is rotationally driven by a drive device (not illustrated). By controlling the rotation of the feed roller 35c, the position of the dancer roller 35d is adjusted.

### <Heat Treatment Unit 40>

The heat treatment unit 40 is equipment where the strip-shaped workpiece A is heat-treated while being conveyed. The heat treatment unit 40 is connected to the unwinding unit 30 via a connecting part 70. The connecting part 70 is provided with an outlet for the unwinding unit 30 and an inlet for the heat treatment unit 40. A path through which the workpiece A passes is formed in the connecting part 70. The workpiece A is conveyed from the unwinding unit 30 to the heat treatment unit 40 through the connecting part 70. The path for the workpiece A formed in the connecting part 70 is set to have dimensions slightly larger than the width and thickness of the workpiece A. This reduces the likelihood of interference between the atmosphere of the heat treatment unit 40 and that of the unwinding unit 30.

The heat treatment unit 40 includes an outer wall 41 (furnace body 41), heaters 42, and guide rollers 45 (45a to 45d). The outer wall 41 has therein a processing space 40a where the workpiece A is processed while being conveyed. The outer wall 41 encloses the processing space 40a in which the heaters 42 and the guide rollers 45 are arranged.

### <Guide Rollers 45>

The guide rollers 45 are provided within the processing space 40a. The guide roller 45 is a roller that guides the workpiece A. The conveyance route along which the workpiece A is conveyed is set by the guide rollers 45. The guide roller 45 is configured to rotate in a driven manner as the workpiece A is conveyed. In this embodiment, each guide roller 45 is a substantially cylindrical roller. A guide roller 45a is provided near the inlet (connecting part 70) of the heat treatment unit 40. Plural guide rollers 45b are arranged at a predetermined pitch from the inlet to an outlet in a lower portion of the heat treatment unit 40. Plural guide rollers 45c are arranged in an upper portion of the heat treatment unit 40 while being offset by half a pitch from the plural guide rollers 45b. The guide roller 45d is provided near an outlet (connecting part 72) of the heat treatment unit 40.

The workpiece A is hung on the guide roller 45a near the inlet of the heat treatment unit 40 and conveyed downward. Thereafter, the workpiece A is alternately hung around the upper and lower guide rollers 45b and 45c in sequence from the inlet toward the outlet. Thus, in the heat treatment unit 40, the workpiece A moves vertically up and down as it progresses from the inlet to the outlet.

### <Heater 42>

The heater 42 is equipment for heating the workpiece A. In this embodiment, the heaters 42 are arranged around the workpiece A which progresses from the inlet to the outlet, in a way that appears to fold up and down. The heater 42 is also arranged in each gap between portions of the workpiece A, which is folded up and down while being hung over the guide rollers 45b and 45c. Each heater 42 is arranged to face the workpiece A. The heater 42 may be fixed, for example, by a heater holder or a support.

In this embodiment, a far-infrared heating type plate heater is used as the heater 42. Various types of heaters may be used as the heater 42, depending on the heating temperature, heating atmosphere, and the like. For example, a cylindrical heater may be used as the heater 42, in addition to the plate heater. The material of the heater 42 is not particularly limited, and a metal sheath heater, a ceramic heater, a lamp heater, or the like may be used. The heater 42 is not limited to the far-infrared heating type heater. In the case of an atmospheric furnace, for example, a hot-air heating type heater that blows hot air onto a workpiece or an infrared heating type lamp heater may be used as the heater 42. The heat-treated workpiece A is conveyed out toward the cooling unit 50 through the guide roller 45d provided near the outlet.

### <Cooling Unit 50>

The cooling unit 50 is equipment in which the workpiece A heat-treated in the heat treatment unit 40 is cooled while being conveyed. The cooling unit 50 is connected to the heat treatment unit 40 via the connecting part 72. The connecting part 72 is provided with the outlet for the heat treatment unit 40 and an inlet for the cooling unit 50.

Although a detailed illustration is omitted, the cooling unit 50 may include a cooling roller, plural guide rollers, and an outer wall 51. The cooling unit 50 may be provided with plural cooling rollers. The outer wall 51 encloses a processing space in which the plural cooling rollers and the plural guide rollers are disposed. The plural cooling rollers and the plural guide rollers set a conveyance route along which the workpiece A is conveyed in the cooling unit 50.

The cooling roller is a roller configured to allow the circulation of a refrigerant. The workpiece A is cooled by contacting a surface of the cooling roller. The cooling roller may be connected to a drive device (not illustrated). The cooling roller can rotate along the conveyance direction at a set conveyance speed.

In this embodiment, the workpiece A is cooled to about room temperature in the cooling unit 50. The temperature to which the workpiece A is cooled is not particularly limited. Note that the configuration of the cooling unit 50, including the guide rollers, the cooling rollers, and the like, is not particularly limited.

The cooled workpiece A is conveyed to the winding unit 60 through a connecting part 74. The cooling unit 50 does not necessarily have to be provided in the heat treatment apparatus 10.

The cooling unit 50 is connected to the winding unit 60 via the connecting part 74. The connecting part 74 includes an outlet for the cooling unit 50 and an inlet for the winding unit 60. The cooled workpiece A is conveyed to the winding unit 60 through the connecting part 74.

### <Winding Unit 60>

The winding unit 60 is equipment that winds up the workpiece A. The winding unit 60 houses the winding roll A2 for winding up the workpiece A that has been cooled through the cooling unit 50.

The winding unit 60 includes the outer wall 61 surrounding internal equipment and the winding roll A2. The winding unit 60 includes the winding shaft 62 and plural rollers 65. The winding roll A2 is attached to the winding shaft 62, and the workpiece A, which has been heat-treated in the heat treatment unit 40 and cooled in the cooling unit 50, is wound onto the winding roll A2. By rotationally driving the winding shaft 62, the workpiece A is wound onto the winding roll A2.

Within the space enclosed by the outer wall 61 of the winding unit 60, the plural rollers 65 that set the conveyance route for the workpiece A are provided. The plural rollers 65 set the conveyance route along which the workpiece A is conveyed within the winding unit 60. The workpiece A conveyed from the cooling unit 50 is hung over the roller 65 near the inlet (connecting part 74) of the winding unit 60, then hung around the plural rollers 65 in the predetermined order, and eventually wound onto the winding roll A2. The plural rollers 65 include guide rollers 65a, a dancer roller 65b, the tension detection roller 65c, and feed rollers 65d. The dancer roller 65b is configured to be movable within a predetermined range. The dancer roller 65b can be moved, for example, to secure a necessary extra length of the workpiece A when the winding roll A2 is replaced. A tension detector (not illustrated) is attached to the tension detection roller 65c. The feed roller 65d feeds out the necessary extra length of the workpiece A when the workpiece A is attached to a new winding roll A2 after the replacement of the winding roll A2.

### <Vacuum Pump 80>

The heat treatment apparatus 10 includes a vacuum pump 80. Interior spaces of the unwinding unit 30, the heat treatment unit 40, the cooling unit 50, and the winding unit 60 described above are enclosed by the outer walls 31, 41, 51, and 61, respectively. The unwinding unit 30, the heat treatment unit 40, the cooling unit 50, and the winding unit 60 have spaces isolated from an external space by the outer walls 31, 41, 51, and 61, respectively. The spaces inside the outer walls 31, 41, 51, and 61 communicate with each other when the workpiece A is processed. The vacuum pump 80 is connected to the outer walls 31, 41, 51, and 61 of the respective units.

The vacuum pump 80 reduces the pressure in the spaces inside the unwinding unit 30, the heat treatment unit 40, the cooling unit 50, and the winding unit 60 (the processing spaces 40a in the heat treatment unit 40). In this embodiment, the workpiece A is processed under a predetermined vacuum atmosphere that has a pressure lower than atmospheric pressure.

The connection form of the vacuum pump 80 is not particularly limited. Plural vacuum pumps 80 may be provided, and the respective vacuum pumps 80 may be connected to the unwinding unit 30, the heat treatment unit 40, the cooling unit 50, and the winding unit 60. Alternatively, pipes may be branched from one vacuum pump 80 to reduce the pressure inside some of the unwinding unit 30, the heat treatment unit 40, the cooling unit 50, and the winding unit 60.

The pipe of the vacuum pump 80 is provided with vacuum valves 81 to 84 for adjusting the vacuum level in each unit.

The vacuum valves 81 to 84 are configured to be switchable between the connection of each unit to the vacuum pump 80 and the disconnection of each unit from the vacuum pump 80. In a case where the vacuum level of each unit is not adjusted, open/close valves may be used instead of the vacuum valves 81 to 84.

A door 70a is provided at the inlet of the heat treatment unit 40 (in this embodiment, the connecting part 70). The door 70a is closed when replacing the unwinding roll A1 or the like. By closing the door 70a when replacing the unwinding roll A1 or the like, the atmosphere of the heat treatment unit 40 (in this embodiment, a reduced pressure state) can be maintained. The door 70a may be closed when the workpiece A passes through the connecting part 70, such as when the unwinding roll A1 is replaced. When the remaining workpiece A on the unwinding roll A1 is nearly depleted, the unwinding roll A1 is replaced with a new one. The end of a workpiece A on the newly installed unwinding roll A1 after the replacement and the end of the workpiece A from the previous roll before the replacement are joined together. With the workpiece A remaining in the processing space 40a, the unwinding roll A1 can be replaced while maintaining the atmosphere in the heat treatment unit 40, allowing for a quick recovery of the apparatus after the replacement of the unwinding roll A1.

A door 74a is provided at the outlet of the cooling unit 50 (in this embodiment, the connecting part 74). Like the door 70a, the door 74a can maintain the atmosphere (in this embodiment, the reduced pressure state) in the cooling unit 50 by closing the door 74a when replacing the winding roll A2 or the like. The door 74a may be closed when the workpiece A passes through the connecting part 74, such as when the winding roll A2 is replaced. When the amount of workpiece A wound on the winding roll A2 becomes significant, the winding roll A2 is replaced with a new one. A leading edge of the newly installed winding roll A2 after the replacement and the end of the workpiece A are joined together. With the workpiece A remaining in the processing space, the winding roll A2 can be replaced while maintaining the atmosphere in the cooling unit 50, allowing for a quick recovery of the apparatus after the replacement of the winding roll A2.

In general, a heat treatment apparatus may have an opening in a furnace body so as to feed a strip-shaped workpiece along a conveyance route, to perform maintenance of the interior of the furnace body, and the like. The heat treatment apparatus disclosed herein will be described below by using the configuration of the heat treatment unit 40 as an example.

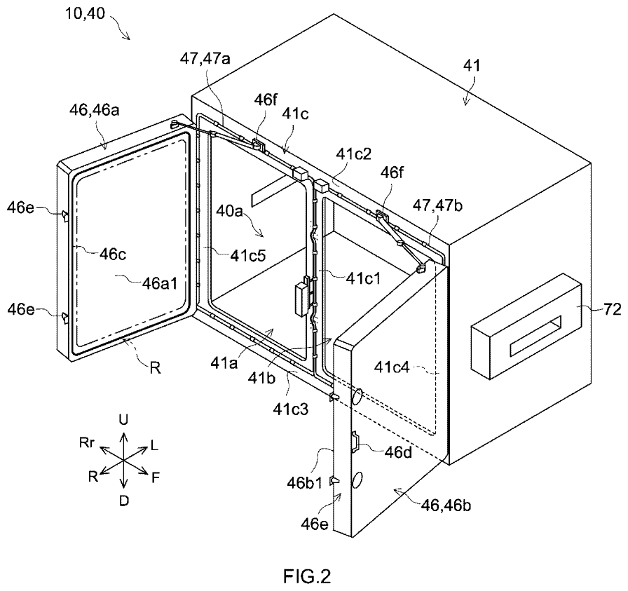

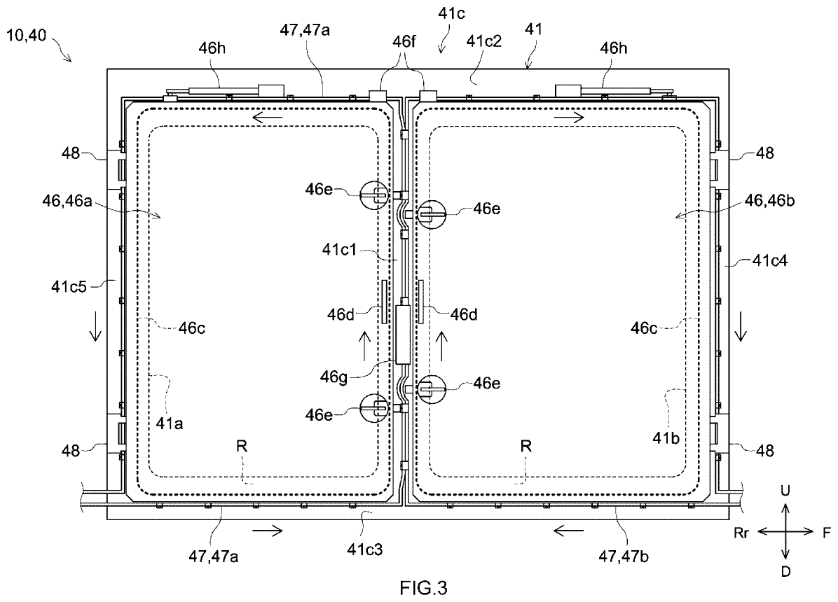

FIG. 2 is a perspective view of the heat treatment unit 40 with a door 46 opened. In FIG. 2, the illustration of the heater 42, the guide rollers 45, and the like inside the heat treatment unit 40 is omitted. FIG. 3 is a plan view of the heat treatment unit 40 with the door 46 closed. In FIG. 3, the plane of the heat treatment unit 40 as viewed facing the left side is schematically illustrated.

As illustrated in FIG. 2, the heat treatment unit 40 includes a furnace body 41, the door 46, and pipes 47.

The furnace body 41 has a substantially rectangular parallelepiped shape. The furnace body 41 has therein the processing space 40a where the workpiece A is heat-treated. The heater 42, the guide rollers 45, and the like are provided in the processing space 40a within the furnace body 41 (see FIG. 1). Within the processing space 40a, a member that supports the heater 42, the guide rollers 45, and the like may be provided. The furnace body 41 is not particularly limited as long as it can block the interior atmosphere. The furnace body 41 may be made of a metal plate (such as a stainless steel plate or the like) having a required thickness. The furnace body 41 may include a heat insulating material. The furnace body 41 may have its inner surface made of a heat insulating material and its outer surface made of a metal plate.

The material, thickness, and the like of the configuration of the furnace body 41 are set as appropriate according to a desired processing temperature, pressure, and the like of the target workpiece A. The furnace body 41 may also include a stiffener that reinforces the furnace body 41.

Openings 41a and 41b are formed in the furnace body 41. In this embodiment, the two openings 41a and 41b are formed in a right side portion 41c of the furnace body 41. The openings 41a and 41b are opened in a substantially rectangular shape with a center portion 41cl of the side portion 41c interposed therebetween. The opening 41a is formed on the rear side of the heat treatment unit 40, while the opening 41b is formed on the front side of the heat treatment unit 40. The side portion 41c is mostly opened except for the center portion 41c1, an upper portion 41c2, a lower portion 41c3, a front portion 41c4, and a rear portion 41c5. An opening area of each of the openings 41a and 41b is not particularly limited, but may be 80% or more, or 90% or more, of an area inside the outer edge of the side portion 41c, which is positioned to face the processing space 40a.

The heat treatment unit 40 has doors 46a and 46b corresponding to the openings 41a and 41b, respectively. The doors 46a and 46b close the openings 41a and 41b of the furnace body 41, respectively. During the heat treatment or the like of the workpiece A, the openings 41a and 41b are closed by the doors 46a and 46b. The door 46a is provided at the rear side of the heat treatment unit 40, and the door 46b is provided at the front side of the heat treatment unit 40. The doors 46a and 46b are opened when feeding the workpiece A along the conveyance route or when performing maintenance inside the furnace body 41. Larger areas of the openings 41a and 41b improve workability for feeding, maintenance, and the like. The doors 46a and 46b are opened and closed with their axes oriented in the vertical direction.

<Doors 46a and 46b>

The doors 46a and 46b are substantially rectangular plate-shaped members that are each one size larger than the openings 41a and 41b, respectively. The thickness of each of the doors 46a and 46b is substantially the same as the thickness of the furnace body 41 so as to allow the inside and outside of the furnace to be insulated. A seal material 46c is provided on inner surfaces 46al and 46b1 of the doors 46a and 46b. Suitable examples of the seal material 46c include sheet gaskets such as a carbon fiber-based one, rubber seal materials such as a silicone-based one, and O-rings such as one made of fluorine rubber or EPDM. The seal material 46c may be disposed in a recess (e.g., a ridge-shaped recess with a cross section) provided in the inner surfaces 46al and 46b1 of the doors 46a and 46b. The sealing material 46c is provided continuously at the peripheral edges of the doors 46a and 46b. Providing the seal material 46c at the boundary of an open/closed part of the heat treatment apparatus 10 (in this embodiment, the doors 46a and 46b) helps to maintain the atmosphere inside the processing space 40a.

The seal material 46c is continuously formed in a substantially rectangular shape. The seal material 46c is provided in a region R that overlaps the peripheral edges of the openings 41a and 41b of the furnace body 41 when the doors 46a and 46b are closed. The seal material 46c is provided continuously along the circumferential direction such that it is positioned to surround each of the openings 41a and 41b. The continuous provision of the seal material 46c along the circumferential direction presses the seal material 46c against the furnace body 41 around the openings 41a and 41b when the doors 46a and 46b are closed. This helps to maintain the airtightness of the processing space 40a.

As illustrated in FIG. 3, the furnace body 41 and the doors 46a and 46b are connected together via hinges 48. Although not particularly limited, two hinges 48 are provided at the upper and lower portions of the combined doors 46a and 46b. Attaching each of the doors 46a and 46b to plural hinges 48 stabilizes the opening and closing of the doors 46a and 46b.

The doors 46a and 46b are provided with handles 46d. One handle 46d is provided on the front side (right side of the paper) of the door 46a, while the other handle 46d is provided on the rear side (left side of the paper) of the door 46b. A lock 46e is provided at each of upper and lower portions of the handle 46d. By fastening the locks 46e, the sealing of the doors 46a and 46b can be enhanced. In a case where the heat treatment unit 40 is a vacuum furnace, unintended opening of the doors 46a and 46b during re-pressurization can be prevented by eliminating any time lag, i.e., any delay in stopping the re-pressurization gas supply within the processing space 40a. Electromagnetic locks 46f are provided at the upper portions of the doors 46a and 46b. The electromagnetic lock 46f is a safety device that has its lock released when conditions such as furnace pressure, furnace temperature, and conveyance stoppage are met. An operation box 46g is provided between the doors 46a and 46b. The operation box 46g includes a select switch, an emergency stop button, and the like for applying the electromagnetic lock 46f and releasing the electromagnetic lock 46f after the above-mentioned conditions are met. Each of the upper end portions of the doors 46a and 46b and the upper portion 41c2 of the furnace body 41 may be connected to each other via a door closer 46h. The connection between each of the doors 46a and 46b and the furnace body 41 via the door closer 46h reduces the momentum caused when the doors 46a and 46b are closed. This may reduce damage to the seal material 46c.

When the door 46a or 46b is closed, the seal material 46c is pressed against the periphery of the opening 41a or 41b formed in the side portion 41c. In the furnace body 41, each of the pipes 47 is attached around the region R against which the seal material 46c is pressed.

### <Pipe 47>

The pipe 47 is a pipe through which a refrigerant flows. The refrigerant is supplied to the pipes 47 by a refrigerant supply device (not illustrated). Although not particularly limited, water or the like can be used as the refrigerant. The temperature of the refrigerant supplied to the inside of the pipe 47 is lower than the ambient temperature inside the processing space 40a, such as room temperature. The kind and temperature of the refrigerant are not particularly limited and may be set as appropriate according to the ambient temperature inside the processing space 40a. Pipes 47a and 47b may be connected to respective refrigerant supply devices. The pipes 47a and 47b may be connected to a common refrigerant supply device.

In this embodiment, the pipes 47 are attached to the periphery of the doors 46a and 46b. The pipes 47 include the pipe 47a attached to the periphery of the door 46a and the pipe 47b attached to the periphery of the door 46b. The pipes 47a and 47b are disposed continuously in a substantially rectangular shape around the doors 46a and 46b, respectively. The pipe 47a is attached to a lower portion 41c3, the center portion 41c1, an upper portion 41c2, and a rear portion 41c5 of the side portion 41c. The pipe 47b is attached to the lower portion 41c3, the center portion 41c1, the upper portion 41c2, and a front portion 41c4 of the side portion 41c. In the center portion 41c1, the pipes 47a and 47b are bundled together. The pipes 47a and 47b are bent rearward in a substantially arc shape in such a manner that they do not interfere with the lock 46e at the center portion 41c1. The refrigerant flows through the pipes 47a and 47b along the direction indicated by the arrows in FIG. 3.

During the heat treatment of the workpiece A, the workpiece A is heated within the processing space 40a with the doors 46a and 46b closed. At this time, the refrigerant is supplied to the pipes 47a and 47b. The supply of the refrigerant begins, for example, before the heater 42 (see FIG. 1) is started.

In the embodiment described above, the heat treatment apparatus 10 includes the furnace body 41, the doors 46a and 46b, and the pipes 47. The furnace body 41 has therein the processing space 40a where the workpiece A is heat-treated, and it is provided with the openings 41a and 41b. The doors 46a and 46b close the openings 41a and 41b of the furnace body 41, respectively. A refrigerant flows through the pipes 47. The doors 46a and 46b are provided with the seal material 46c in the region R that overlaps the peripheral edges of the openings 41a and 41b of the furnace body 41 when the doors 46a and 46b are closed. The seal material 46c is cooled indirectly by the refrigerant flowing through the pipes 47 in close proximity with the seal material. This reduces an increase in temperature of a portion of the furnace body 41 where the seal material 46c contacts, even when the temperature in the processing space 40a increases. As a result, deterioration of the seal material 46c is reduced, which helps to maintain the airtightness in the processing space 40a of the heat treatment apparatus 10. In the heat treatment apparatus 10, the pipes 47 are attached to the periphery of the region R in the furnace body 41 against which the seal material 46c is pressed. Each pipe 47 to which the refrigerant is supplied is provided on the side of the furnace body 41, not on the side of the doors 46a and 46b, which are driven, thereby simplifying the attachment structure of the pipes 47 and improving maintainability, for example, when replacing the pipe 47. In addition, the distance between the pipe 47 through which the refrigerant flows and the seal material 46c is easily shortened, regardless of the thickness of the doors 46a and 46b.

In the embodiment described above, the pipes 47 are attached to the periphery of the doors 46a and 46b. This prevents the doors 46a and 46b from interfering with the pipes 47 even when the doors 46a and 46b are opened or closed. The attachment structure between the furnace body 41 and the pipes 47 can be simplified.

In the heat treatment apparatus 10, the vacuum pump 80 that reduces the pressure in the processing space 40a is connected to the furnace body 41. In the reduced pressure state, the adhesion of the seal material 46c to the furnace body 41 is improved. As a result, the cooling efficiency of the seal material 46c can be improved.

However, the attachment structure of the pipes 47 to the furnace body 41 is not particularly limited. In this embodiment, the pipe 47 is provided around each of the doors 46a and 46b, in close proximity to the doors 46a and 46b. In the heat treatment apparatus 10, the pipes 47 are positioned to pass through a space that is enclosed by the furnace body 41, the door 46a, 46b, and the hinge 48 when the door 46a, 46b is closed.

### <Hinge 48>

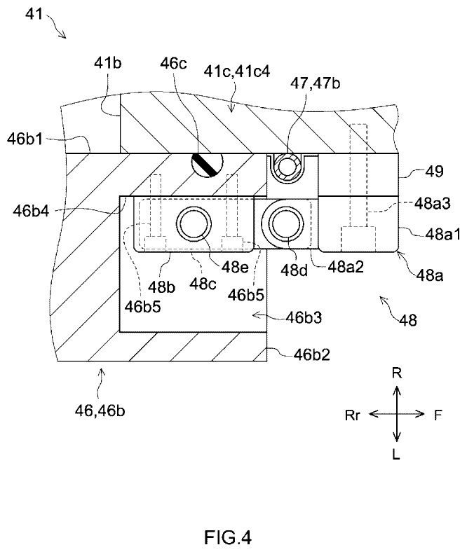

FIG. 4 is a schematic diagram of the hinge 48. Specifically, FIG. 4 illustrates the cross-section of a portion where the furnace body 41 and the door 46b are connected together, as viewed from above. The structure of the portion where the furnace body 41 and the door 46a are connected together can be substantially the same as that of a portion where the furnace body 41 and the door 46b are connected together, and thus a detailed description thereof is omitted. The hinge 48 includes a first member 48a, a second member 48b, a third member 48c, a first shaft 48d, and a second shaft 48e. As illustrated in FIG. 4, the hinge 48 is a so-called multiaxial hinge, which has plural shaft members. Thus, the door 46b can be placed and easily pressed around the opening 41b in a balanced manner. As a result, the airtightness in the processing space 40a (see FIG. 1) is easily maintained. However, the hinge 48 is not limited to a multiaxial hinge.

The first member 48a is a member that is connected to the furnace body 41. The first member 48a has a portion 48al connected to the furnace body 41 and a portion 48a2 connected to the first shaft 48d. The first member 48a is connected to the front 41c4 of the side portion 41c of the furnace body 41 by bolts 48a3. The first member 48a is connected to the furnace body 41 via a spacer 49. The second member 48b is a member connected to the door 46b. A side surface 46b2 of the door 46b is provided with a recess 46b3 in which the second member 48b is housed. Inside the recess 46b3, a substantially rectangular space is formed. The second member 48b is attached to the inner peripheral surface 46b4 of the recess 46b3 on the furnace body 41 side by bolts 46b5.

The third member 48c is a member coupling the first member 48a and the second member 48b. The third member 48c is connected to the first member 48a and the second member 48b via the first shaft 48d and the second shaft 48e, respectively. The first shaft 48d is a shaft member coupling the first member 48a and the third member 48c. The second shaft 48e is a shaft member coupling the second member 48b and the third member 48c. The first shaft 48d and the second shaft 48e are substantially cylindrical shaft members. The first shaft 48d is inserted into a substantially center portion of the portion 48a2 of the first member 48a and also into the third member 48c. The second shaft 48e is inserted into a substantially center portion of the second member 48b and also into the third member 48c.

In the embodiment described above, the pipe 47 is positioned to pass through a space that is enclosed by the furnace body 41, the door 46b, and the hinge 48 when the door 46b is closed. With this configuration, the pipe 47 can be located closer to the door 46b. As a result, the cooling efficiency of cooling the seal material 46c is improved, which suppresses the deterioration of the seal material 46c. During opening/closing of the door 46b, the pipe 47 does not interfere with the door 46b.

In the embodiment described above, the spacer 49 is provided between the hinge 48 and the furnace body 41. In this way, the hinge 48 is attached to the furnace body 41 or the door 46b via the spacer 49, thereby facilitating the provision of a space through which the pipe 47 passes.

The above is a detailed description of the technology disclosed herein through the specific embodiments, but those are illustrative only and do not limit the scope of the claims. Accordingly, the technology described in claims includes various variations and modifications of the embodiments described above.

The present specification also includes the following Items 1 to 6. The following items 1 to 6 are not limited to the above embodiments.

### Item 1:

A heat treatment apparatus comprising:
a furnace body having therein a processing space where a workpiece is heat-treated, the furnace body being provided with an opening;
a door configured to close the opening of the furnace body; and
a pipe through which a refrigerant flows, wherein
the door is provided with a seal material in a region that overlaps a peripheral edge of the opening of the furnace body when the door is closed, and
the pipe is attached around a region in the furnace body against which the seal material is pressed.

### Item 2:

The heat treatment apparatus according to Item 1, wherein
the furnace body and the door are connected to each other via a hinge, and
the pipe passes through a space enclosed by the furnace body, the door, and the hinge when the door is closed.

### Item 3:

The heat treatment apparatus according to Item 2, wherein
the hinge includes a first member connected to the furnace body, a second member connected to the door, a third member coupling the first member and the second member, a first shaft coupling the first member and the third member, and a second shaft coupling the second member and the third member.

### Item 4:

The heat treatment apparatus according to any one of Items 1 to 3, wherein the seal material is provided continuously along a circumferential direction so as to be positioned to surround the opening.

### Item 5:

The heat treatment apparatus according to any one of Items 1 to 4, wherein the pipe is attached around the door.

### Item 6:

The heat treatment apparatus according to any one of Items 1 to 5, wherein a vacuum pump that reduces pressure in the processing space is connected to the furnace body.

What is claimed is:

1. A heat treatment apparatus, comprising:
a furnace body having therein a processing space where a workpiece is heat-treated, the furnace body being provided with an opening;
a door configured to close the opening of the furnace body; and
a pipe through which a refrigerant flows, wherein
the door is provided with a seal material in a region that overlaps a peripheral edge of the opening of the furnace body when the door is closed, and
the pipe is attached around a region in the furnace body against which the seal material is pressed.

2. The heat treatment apparatus according to claim 1, wherein
the furnace body and the door are connected to each other via a hinge, and
the pipe passes through a space enclosed by the furnace body, the door, and the hinge when the door is closed.

3. The heat treatment apparatus according to claim 2, wherein
the hinge includes a first member connected to the furnace body, a second member connected to the door, a third member coupling the first member and the second member, a first shaft coupling the first member and the third member, and a second shaft coupling the second member and the third member.

4. The heat treatment apparatus according to claim 1, wherein
the seal material is provided continuously along a circumferential direction so as to be positioned to surround the opening.

5. The heat treatment apparatus according to claim 1, wherein
the pipe is attached around the door.

6. The heat treatment apparatus according to claim 1, wherein
a vacuum pump that reduces pressure in the processing space is connected to the furnace body.
